(19) United States
(12) Patent Application Publication
(10) Pub. No.: US 2005/0262029 A1
(43) Pub. Date: Nov. 24, 2005

(54) Method and a computer program for regulating the energy flow in an energy network, and as well as a system for electronically auctioning energy

(75) Inventor: Barend Den Ouden, Bennekom (NL)

Correspondence Address: Steven M. Koehler;Westman, Champlin & Kelly, Suite 1600, 900 Second Avenue South, Minneapolis, MN, 55402-3319, US

(73) Assignee: Amsterdam Power Exchange Spotmarket B.V., Amsterdam (NL)

(21) Appl. No.: 10/777,446

(22) Filed: Feb. 12, 2004

Related U.S. Application Data
(63) Continuation of application No. PCT/NL03/00217, filed on Mar. 21, 2003.

(30) Foreign Application Priority Data
Sep. 4, 2002 (NL) NL 1021394

(51) Int. Cl. G06F 17/00

(52) U.S. Cl. 705/412

(57) ABSTRACT

A method and a computer programme for regulating the energy flow in an energy network comprises at least a first and a second area comprising producers and consumers, in which the energy network comprises at least one network connection that limits the transportation capacity of the energy network between said first area and said second area. The method and the computer programme comprise fixing an isolated energy price in the first area and in the second area in proportion to the intended energy production by the producers and the intended energy consumption by the consumers, adjusting said isolated energy prices in said first area and in said second area on the basis of simulated transportation of energy over the network connection and on the basis of the available transportation capacity, and making the adjusted energy prices for the first area and the second area and/or the actual transportation of energy accessible to the producers and/or the consumers and/or the operators of the network. The invention furthermore relates to a system for the electronic auctioning of energy in an energy network over an auctioning network and to a computer programme for the auctioning of energy in such a system.

### CROSS-REFERENCE TO RELATED APPLICATION

This application claims priority and is a continuation application of International application No. PCT/NL03/00217, filed Mar. 21, 2003, and published in English.

### BACKGROUND OF THE INVENTION

The invention relates to method for regulating the energy flow in an energy network. The invention furthermore relates to a computer programme for carrying out such a method and to a system for electronically auctioning energy in an energy network via an auctioning network.

The past decade a trend has set in according to which tasks that were previously considered to be a specific government domain are now left to the free market to a greater or lesser extent. An example of such a task is the supply of energy, such as the supply of electricity.

Another trend is the globalisation of trade and commerce. This trend can also be observed in the electricity businesses. The trading in electricity across (national) borders is one of the most relevant aspects of the integration of the individual (so far) electricity markets. For example, one of the objects at for the electricity market within the European Union is to realise such integration.

U.S. Pat. No. 5,237,507 discloses a method and system for step-by-step introduction of an electronically simulated free market by fixing and announcing the prices of electricity and the amount of energy to be imported or exported in advance. By now, a number of countries or areas have introduced a free market for electricity, with a special electricity exchange where trading in electricity can take place. An example of such an exchange for the Netherlands is the Amsterdam Power Exchange (APX).

The European electricity market has to a large extent been strongly fragmented until now. The transportation capacity for electricity between said countries or areas is limited, so that the possibilities as regards the import and/or export of electricity between countries or areas are limited. The network connections between the various electricity networks of said countries or areas were never designed with a view to facilitating a lively trade in energy. Consequently, the fact that a choice must be made between optimising the mechanism of supply and demand in the individual areas and optimising the use of the transportation capacity of the network connection between the individual areas constitutes a problem.

Furthermore, a large portion of the energy that is generated in said areas is thermally generated electric energy (coal-fired power plants, nuclear power plants). This form of power production is characterized in part by a low degree of flexibility as regards the starting up and shutting down of the energy generating process. A precise regulation of the supply of and the demand for electricity is essential in such a situation, therefore.

### SUMMARY OF THE INVENTION

It is an object of the invention to obtain such a precise regulation of supply and demand in a fragmented market as described above with a view to optimising the use of the transportation and production capacity.

This object is accomplished in that the invention provides a method for regulating the energy flow in an energy network comprising at least a first and a second area comprising producers and consumers, in which the energy network comprises at least one network connection that limits the transportation capacity of the energy network between said first area and said second area, which method comprises the following steps, wherein:
fixing isolated energy prices in the first area and in the second area in proportion to the intended energy production by the producers and the intended energy consumption by the consumers;
adjusting said isolated energy prices in said first area and in said second area on the basis of simulated transportation of energy over the network connection and on the basis of the available transportation capacity;
making data on the energy flow for the first area and the second area accessible to the producers and/or the consumers and/or an operator of the network connection.

Since the available transportation capacity between the first and the second area forms part of the process of optimising the mechanism of supply and demand in the individual areas, the use of the method leads to a simultaneous optimisation of the mechanism of supply and demand in the individual areas and of the use of the network connection. The method effects a hard relation between the price for the energy and the price for the transportation capacity. When subsequently the energy flow data, such as the adjusted energy prices or the actual transportation of energy, are made accessible to the producers and/or the consumers and/or the network operators, it becomes possible to regulate the energy production and the energy consumption in such an energy network, and the energy producers will be aware of the energy production that is expected of them in advance. The network operators can take measures aimed at safeguarding the supply of energy on the basis of said energy flow data. Consequently, the term regulating the energy flow is understood to include the furnishing of information on the future energy flow, on the basis of which information the parties in question can take measures.

It will be understood that the energy producers and consumers may be represented by traders and/or other intermediaries. In addition to that, data relating to the adjusted energy price, such as the actual transportation of energy, can be made accessible together with or instead of the adjusted energy prices. Important is that the energy producers, for example, can be directly or indirectly informed of the energy production that is expected of them. Besides the energy producers, or instead of said energy producers, also the operators or managers of the energy network may be informed of the energy production. This is important for said operators in connection with guaranteeing the energy supply via the energy network they manage. If the energy production exceeds the maximum transportation capacity, the operators must take measures.

The use of the method makes it possible to show which bids of the market parties have been accepted after execution of the aforesaid method steps.

If the transportation capacity of the network connection is sufficient, a common adjusted energy price can be fixed, so that the first and the second area will form a common energy market.

The energy producers and consumers can make any previously acquired rights to transportation capacity available, so that said rights can be taken into account in the optimisation process. The advantage of this is that a possibility has been created to use any unused or surplus transportation capacity after all.

The acquired rights to transportation capacity can be made available on a specific condition. This condition may imply that the transportation capacity will be available when the difference between the energy prices in the area of import and the energy prices in the area of export are greater than or equal to zero. This makes it possible to limit the financial risk for the party offering the transportation capacity. Furthermore, the occurrence of energy flows over the network connection in a direction opposed to the direction that the difference in price between the countries or areas would justify, is prevented, or at least the possibility of this situation occurring is reduced.

The method according to the invention makes it possible to optimise the long-term physical supply of energy on a daily basis. This provides the market parties with an instrument for long-term planning and optimisation.

In one preferred embodiment, the method is automated and carried out on a computer executing a computer programme for regulating the energy production in dependence on the demand for energy in an energy network, in which the programme comprises at least code portions embodied as instructions on a computer readable medium for carrying out the method as described above.

The invention also relates to a system for the electronic auctioning over an auctioning network of energy in an energy network comprising at least a first and a second area comprising producers and consumers, in which the energy network comprises at least one network connection that limits the transportation capacity of the energy network between said first area and said second area, in which the auctioning network comprises a first unit and a second unit for receiving bids with regard to the supply of and the demand for energy in said first area and said second area for the purpose of fixing an isolated auctioning price in said first area and said second area in dependence on the supply and the demand, and in which the system furthermore comprises an arithmetic unit for adjusting the isolated energy prices in the first area and in the second area on the basis of simulated transportation of energy over the network connection and the available transportation capacity, and in which the system is also arranged for making the adjusted energy prices accessible at least to the producers and/or the consumers via the auctioning network.

Such an auctioning system makes it possible for the available transportation capacity between the first and the second area to form part of the process of optimising the mechanism of supply and demand in the individual areas, in order to realise a simultaneous optimisation of the mechanism of supply and the demand in the individual areas and of the use of the network connection. When subsequently adjusted energy prices are made accessible to producers and the consumers, it becomes possible e.g. to regulate the production of energy and the consumption of energy in such an energy network.

Also in this case it applies that data related to the adjusted energy prices can be made accessible in addition to or instead of the adjusted energy prices, and that besides the producers, or instead of the producers, also the consumers and/or intermediaries may have access to the adjusted energy prices or to data related thereto, such as the actual import or export of energy.

In one preferred embodiment of the invention, the auctioning network is arranged in such a manner that energy producers from one area can make bids on a unit associated with the other area, so that transportation capacity can be made available by making a bid to buy energy in the first area and sell energy in the second area, or vice versa, or by making the transportation capacity available by means of implicit auctioning by a third party. The units are arranged in such a manner that such transportation capacity can be made available on a condition relating to the difference in the energy prices.

In one preferred embodiment of the invention, the auctioning system is arranged in such a manner that the arithmetic unit can make bids in both areas, which bids can only be accepted upon fulfilment of the condition that the difference in the energy prices must be a positive difference.

The invention also relates to a computer programme for the auctioning over an auctioning network of energy in an energy network in a system as described above.

Finally, the invention relates to a method for regulating the energy flow in an energy network comprising at least a first and a second area comprising producers and consumers, in which the energy network comprises a network connection that limits the transportation capacity of the energy network, in a system comprising a combination server, which is communicatively linked to servers of the areas for one or more user units of the producers and the consumers, according to which method:
the servers receive one or more data strings from the units of the producers and the consumers, which data strings contain data on the intended energy production and the intended energy consumption, respectively;
the combination server fixes or receives isolated energy prices in the first area and the second area in proportion to the intended energy production by the producers and the intended energy consumption by the consumers;
the combination server adjusts the isolated energy prices in the first area and in the second area on the basis of simulated transportation of energy over the network connection and the available transportation capacity;
the combination server makes energy flow data for the first area and the second area accessible to the producers and/or the consumers and/or to an operator of the network connection, or said data are made accessible via said combination server.

This method provides a solution for the technical problem that it is impossible in practice to store electrical energy. The method provides a planning mechanism which prevents the producer of electrical energy from producing energy that said producer is unable to sell.

EP 0 893 775 discloses a process and a system for management of electric power supply. A process and a system are concerned in which probabilistic distributions with regard to the spot-market prices for the energy are generated, inter alia on the basis of price functions, assumptions or indirectly obtained data. Such a method provides insufficient guarantees as regards the regulation of the energy production.

### BRIEF DESCRIPTION OF THE DRAWINGS

A few embodiments of the invention will be discussed in more detail by way of example hereinafter, in which discussion reference will be made to the figures, in which:

FIG. 1 schematically shows an energy network comprising two areas, which are interconnected by means of a network connection having a limited transportation capacity;

FIG. 2 shows an energy network and an auctioning network according to one embodiment of the invention;

FIGS. 3A-E illustrate the method according to one embodiment of the invention;

FIGS. 4A-E illustrate the method for conditionally making transportation capacity available; and

FIGS. 5A-C show an energy network in more than two areas.

### DETAILED DESCRIPTION OF THE ILLUSTRATIVE EMBODIMENTS

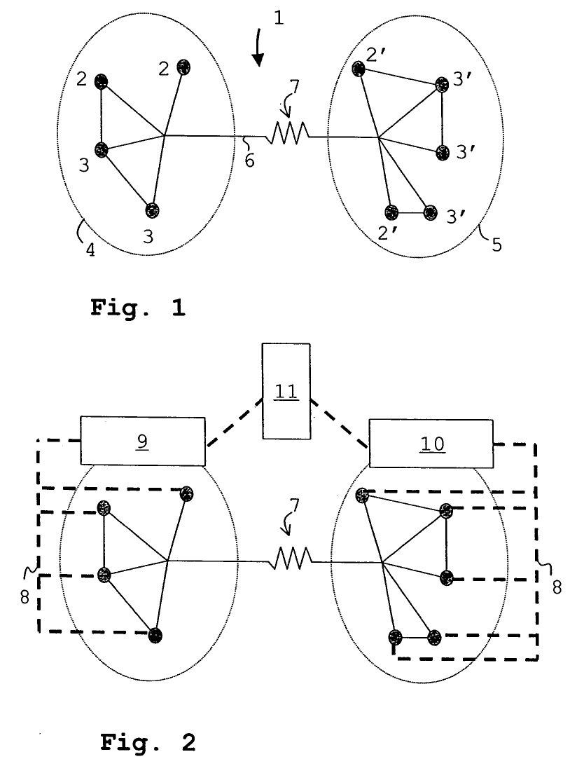

In FIG. 1, an energy network 1 is schematically shown. Such an energy network 1 is an electricity network, for example. The energy network 1 provides a connection between energy producers 2,2′ and energy consumers 3, 3′, jointly referred to as market parties, for the supplying of energy. It will be understood that the energy producers 2, 2′ and the energy consumers 3,3′ may exchange roles. The energy network 1 is present in two areas 4, 5, which areas are interconnected by means of a network connection 6 having a limited or restricted transportation of energy capacity. The limited transportation capacity is schematically represented by the resistor 7. The areas 4 and 5 may be different countries, for example, or different areas within a country or conglomerations of countries. It will be apparent to those skilled in the art that the energy network 1 will be significantly more complicated in practice. The simplified representation of FIG. 1 suffices for the purpose of illustrating the invention, however.

A number of energy producers 2,2′ supply thermally generated electrical energy, which implies that the production of energy cannot be started or stopped instantly. There is a possibility that too much energy is present in the area 4, 5 at some point. It is not possible, however, to store electrical energy in an economically feasible manner, so that it may be attractive in this situation to transmit the surplus energy to another area. Thus, a situation may occur in which the production of energy in area 4 exceeds the demand for energy of the consumers 3. The surplus of energy can be exported to the area 5 over the network connection 6 in that case.

On the other hand, a situation may occur in which the energy producers are unable to meet the demand for energy in their area, because they have reached their maximum production capacity. In that case it may appear to be necessary to import energy. Thus it may be desirable, for example, to import energy from the energy producers 2′ located in the area 5 into the area 4 over the network connection 6, so as to compensate for a shortage in the area 4.

In addition to that it may be more profitable for the energy producers 2, 2′ and/or the energy consumers 3, 3′ to import energy from or export energy to the areas 4, 5 because of differences in the price of the energy.

The limited transportation capacity 7 may form an impediment as regards the transportation of energy over the network connection 6, however.

FIG. 2 shows the energy network 1 in the areas 4 and 5 again. FIG. 2 furthermore shows an auctioning network 8, to which the energy producers 2, 2′ and the others the consumers 3, 3′ are connected. The auctioning network 8 is schematically illustrated in fat, dashed lines. The auctioning network 8 is the Internet, for example, over which the energy producers 2 from the area 4 can offer their energy on a unit or server 9 via user units (not shown). The server 9 runs an application that functions as an electronic marketplace or exchange for energy in the area 4. A similar unit or server 10 is present for the area 5. Such an electronic marketplace for energy, in which the energy producers 2, 2′ and the energy consumers 3, 3′ “meet” is already known. The auctioning network 8 further comprises a combination server or arithmetic unit 11, which runs an application that carries out the method according to the invention. It will be apparent to those skilled in the art that said application is not necessarily run on a separate server at the location of a third party, for example, but that it can also run on one of the servers 9, 10, which servers are interconnected for communicating data from the areas 4 and/or 5. The market parties can approach to units or servers 9 and 10 in a manner which is known, in which market parties from the area 4 can also approach the server 10 of the area 5.

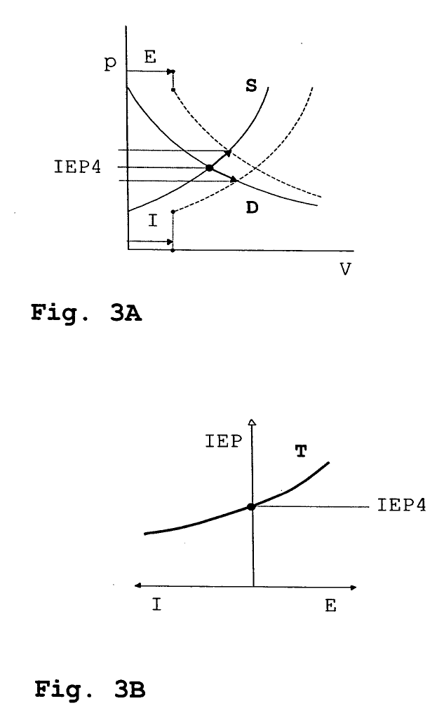

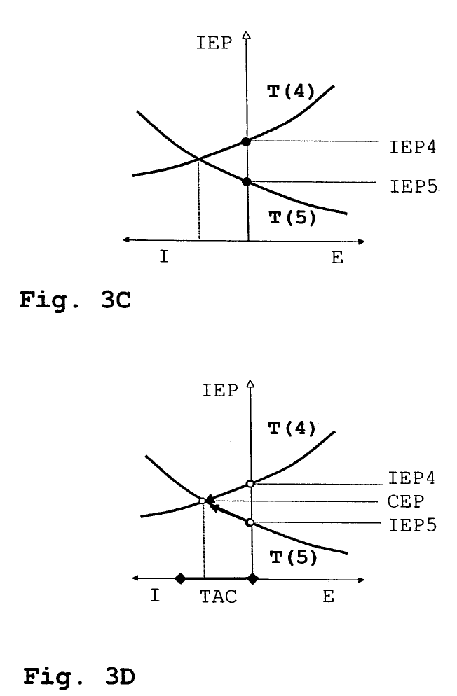

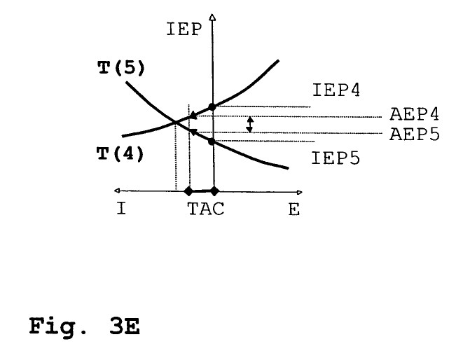

FIGS. 3A-E schematically show the steps that are carried out by the applications that run on the combination server in one embodiment of a method according to the invention.

In FIG. 3A the bids are made on the exchanges associated with the servers 9 and 10 for the individual areas 4 and 5, respectively. Said bids are made by the producers 2, 2′ and the consumers 3, 3′ via data strings containing data on the energy supply and demand, which are sent to the servers 9, 10 from the user units. The bids are represented by the supply curve S and the demand curve D. Subsequently, the isolated energy price IEP4 and IEP5 can be fixed for the areas 4 and 5, respectively, at the point where the curves S and D intersect. This is the current method for the spot markets. A spot market is an exchange on which the energy is traded for the day after the trading day. The servers 9 and 10 are capable of running different exchange or auctioning systems for trading the energy. Preferably, the exchanges are geared to each other as regards the closing times and the units of time for trading energy.

The servers 9 and 10 subsequently simulate transportation of energy (import I, export E) over the network connection 6, as a result of which the isolated energy price will change, as is indicated in FIG. 3A. Such a simulation may e.g. comprise the shifting of the supply and demand curves in the illustrated manner (dashed curve). The isolated energy price for the area 4 will drop when energy is imported from the area 5, whilst the isolated energy price will rise in the case of energy being exported to the area 5. It is noted that the simulation can also be carried out by the combination server 11, on the basis of the input of suitable data from the servers 9, 10.

FIG. 3B shows a transportation curve T, which indicates how the isolated energy price in an area 4 varies along with the amount of energy being imported from and exported to the area 5. Said transportation curve T depends on the volume of energy being traded in the area 4 in relation to the amount of energy being imported or exported over the network connection 6. Said curve T will furthermore depend on the number of bids on the server 9 that ensure flexibility as regards the price, i.e. the steepness of the supply curve S and the demand curve D. If said volume is low and the number of bids is small in proportion to the import and export volumes, the import of energy from or the export of energy to the area 5 will exhibit a strongly rising curve T; the question whether energy is being imported or exported has a major influence on the isolated energy price in the area 4. The opposite can be observed in the case of a large volume and a large number of bids.

The transportation curve T can be constructed both for the area 4 (T(4)) and for the area 5 (T(5)), for example at the servers 9 and 10, respectively. The application that runs on the combination server 11 can subsequently combine the curves (T(4)) and (T(5)) in the representation according to FIG. 3C. After all, the import of energy into one area is identical to the export of energy from the other area. Normally, the isolated energy prices IEP in the areas 4 and 5 are different from each other, because the markets are not integrated in the present situation.

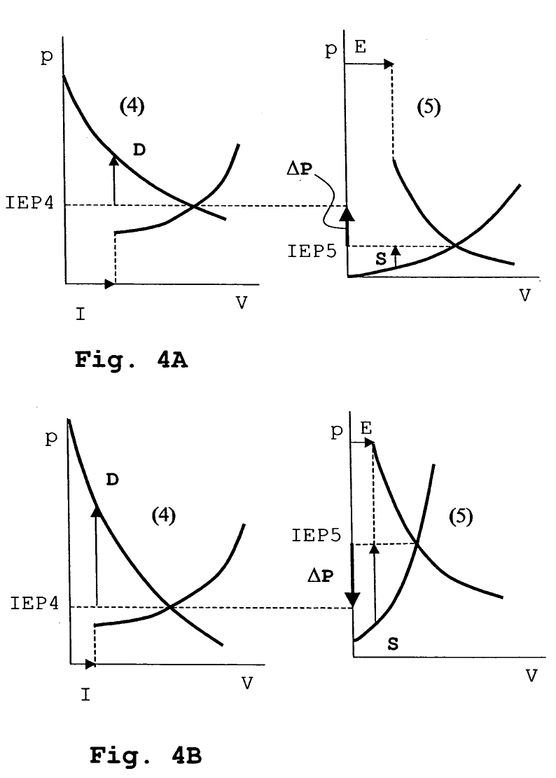

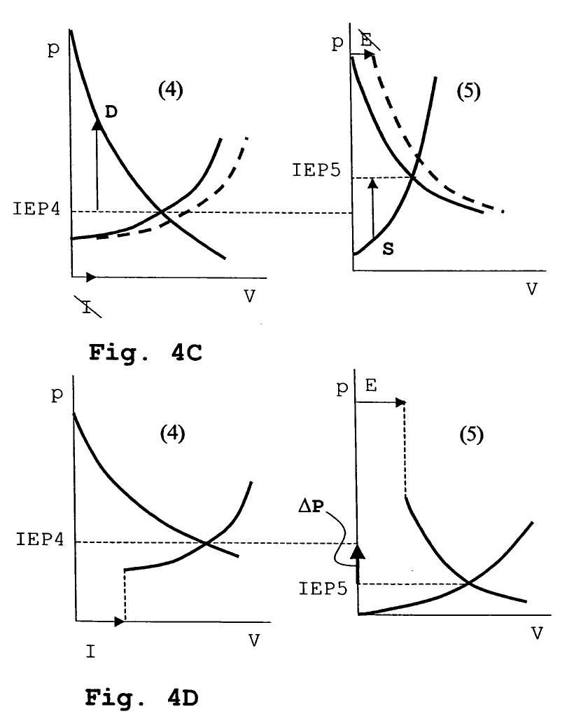

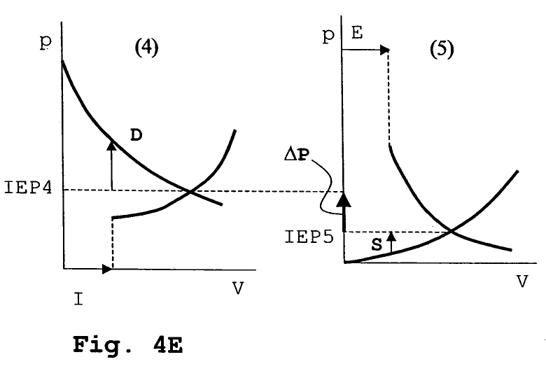

Subsequently, the available transportation capacity 7 of the network connection 6 is determined. The manners in which transportation capacity can be made available will be discussed in the description of FIGS. 4A-D.

Two situations may occur, as is shown in FIGS. 3D and 3E. FIG. 3D shows the situation in which the transportation capacity TAC over the network connection 6 between the areas 4 and 5 is sufficient for the desired transportation of energy. The resulting energy price will be a common energy price CEP for the entire area 4+5 in such a situation. The areas 4 and 5 form an integrated market in that case.

FIG. 3E shows the situation in which the available transportation capacity TAC is insufficient for the desired transportation of energy over the network connection 6. The difference between the isolated energy prices IEP4 and IEP5 will become smaller in this case, resulting in the adjusted energy prices AEP4 and AEP5, as indicated by the arrows in FIG. 3E, but a common energy price CEP for the area 4+5 is not fixed. The energy markets for the areas 4 and 5 are partially integrated.

Because of the limited transportation capacity 7, the proceeds of the auction equal the difference in price AEP4-AEP5 multiplied by the energy being transported over the network connection 6. The transportation capacity 7 is thus implicitly auctioned. The proceeds of this auction may go to the operator of the network connection 6 or to the party or parties that make the transportation capacity available.

The result CEP, or AEP4 and AEP5 in the combination server 11, is subsequently returned to the servers 9 and 10, respectively, so that said servers can make the adjusted energy prices and volumes for the areas 4 and 5, and also the optimised transportation capacity over the network connection 6 between the areas 4 and 5, accessible to the energy producers 2, 2′ and the energy consumers 3, 3′. In this way an at least partially integrated market is created for the different areas 4, 5, each having its own energy exchange. In such a situation an optimum regulation in advance of the energy production is possible.

When the adjusted energy prices AEP4 and AEP5 or the common energy price CEP is known, it can be decided which bids from the participants in the markets will be accepted. In addition to that, the network operators know which transportation capacity in which direction (from area 4 the area 5 or vice versa) they must reserve in the energy network 1 and/or the network connection 6 for which they are responsible. In addition to the adjusted energy prices AEP or a common energy price CEP, or instead thereof, the actual amount of imported energy I and/or exported energy E can be made accessible. Based on this information, the adjusted energy price, for example in the area 4, can be fixed from the curves as shown in FIG. 3A, which price will be identical to the energy price AEP4 as fixed in FIG. 3E.

In one preferred embodiment of the invention, the transportation capacity 7 over the network connection 6 can be made available in various ways. It is noted that according to the invention the method for making the transportation capacity available can also be carried out separately from the method for regulating the energy flow. Hereinafter three alternatives will be discussed.

According to a first alternative, the transportation capacity 7 of the network operators can be made available in its entirety on a daily basis via an implicit auction of transportation capacity between the markets at the servers 9 and 10 on which the energy producers 2, 2′ and the energy consumers 3, 3′ are active. The proceeds of the auction usually go to the operator of the network connection 6 in this situation.

According to a second alternative, the transportation capacity 7 can be auctioned in part on a daily basis, as described for the first alternative. The other part can be explicitly auctioned to the market parties, for example on a daily, weekly, monthly or yearly basis, for use in connection with bilateral (OTC) contracts to be concluded by said parties. In this situation, too, the proceeds of the two auctions usually go to the operator of the network connection 6.

According to a preferred embodiment of the invention, a third alternative concerns the reallocation of rights to transportation capacity of the market parties themselves. In this variant, the method and the system provide the market parties that possess transportation rights for the network connection 6 with a possibility to take said transportation rights to the exchange or to the servers 9-11, for example if the transportation capacity in question is surplus capacity. In general, the market parties to do not know beforehand whether they wish to use the transportation capacity that they have already acquired. This may depend on the energy prices in the different areas, which by definition are only known at the very last moment. This option thus makes it possible to utilise the transportation capacity of the network connection 6 optimally and manage the economic risks for the market parties in a more advantageous manner. In this option, the proceeds of the auction can go to the market parties that have traded the transportation rights.

In a preferred embodiment, this third option can be combined with the second alternative as discussed above. This enables long-term trading in transportation capacity.

Suppose a market party possesses rights to transportation capacity for the transportation of energy from the area 5 to the area 4 over the network connections 6. The market party may have acquired said rights previously via the above-described second alternative or via the current practice of explicit auctions or other forms of allocation of transportation capacity by the network operators. The making available of said transportation rights according to the third option can take place in two ways.

According to the first possibility, a market party 2 in the area 4 offers energy at the server 9 whilst at the same time requesting energy for the area 5 at the server 10, thus using transportation capacity. The bids are put “at market” in the markets of the servers 9 and 10, i.e. as an “order and best”, by the combination server 11. The condition made by the combination server 11 is that the difference in price IEP4-IEP5 between the areas 4 and 5 must be greater than or equal to zero or in line with the intended transportation of energy. This transportation capacity is subsequently available, like the other transportation capacity, and can be used for the method as illustrated in FIGS. 4A-E.

Three situations can be distinguished.

In the first place, a situation may occur in which a market party wishes to use the acquired transportation capacity in order to meet an obligation to supply energy. Suppose, for example, that an energy producer 2′ in the area 5 has an obligation to supply a specific amount of energy to a consumer 3 in the area 4, and the producer 2′ already possesses a right to a specific transportation capacity over the network connection 6. The producer 2′ will make three bids in that case: a bid to sell at the server 9 for the area 4; a bid to buy at the server 10 for the area 5 and a conditional inter-area bid between the bid to buy and the bid to sell. This situation is illustrated in FIG. 4A. In this situation, in which the markets in the areas 4 and 5 behave as expected (i.e. the isolated energy price IEP4 for the area 4 is higher than the isolated energy price IEP5 for the area 5. In this case the proceeds for a producer 2′ are made up of the difference between the selling price and the production price or buying price, including the difference between the market prices ΔP in the areas 4 and 5. It is noted that it is also possible to use the adjusted energy prices AEP instead of the isolated energy prices IEP. In the end it is the fact whether the difference between the energy prices in the areas 4 and 5 is positive or negative that is important rather than the magnitude of said difference in price, which, after all, remains the same or decreases as a result of the transportation capacity being made available. Consequently, the term energy price will be used hereinafter without indicating whether said price relates to the isolated energy price or to the adjusted energy price.

If the markets in the areas 4 and 5 move in a direction contrary to the expected direction, as is shown in FIG. 4B, it will be unprofitable to transmit energy from the area 5 to the area 4, since the market price in the area 4 is lower. It should be noted in this connection that the behaviour of the market is generally not known beforehand, so that generally the participants in the markets must make estimates, with all the risks this involves. After all, transactions must be announced before the definitive energy prices are known. In this case, the proceeds for the producer 2′ comprise a negative component because of the negative difference in price ΔP between the markets.

In the situation that is shown in FIG. 4B, it would be more profitable for the producer 2′ if there would be no transportation of energy over the network connection 6 and the producer 2′ would buy the energy to be supplied at the server 9 and supply said energy to the buyer 3′. The method and the system according to the invention, in which conditional bids can be made, may lead to this more profitable result. This is shown in FIG. 4C. If the market behaviour is contrary to the intended transportation of energy, said transportation of energy will not take place (indicated by the crossed E and I), because the condition laid down at the combination server 11 that the difference in price ΔP between the markets must be positive, has not been met. The producer 2′ buys and sells energy at the respective servers 9 and 10 over the auctioning network 8. This prevents unnecessary use of the limited transportation capacity over the network connection 6, and the proceeds for the producer 2′ are higher than in the situation according to FIG. 4B, since the negative component of the difference in market price ΔP is avoided by deciding not to transmit energy from the area 5 to the area 4. Furthermore, better integration of the markets for the areas 4 and 5 is effected, in the sense that the difference in the energy prices IEP4 and IEP5 in the areas 4 and 5 is smaller than before (dashed curves).

In the second place, a situation may occur in which the producer 2′ does not wish to make use of the already acquired right to transportation capacity over the network 6. Without the method and/or the system according to the invention, said transportation capacity would be lost, or it might be sold to other market parties; in a situation in which it is still uncertain how the markets will behave, however, this will translate into low proceeds for the producer 2′ with regard to the transportation capacity to be sold.

The system in which the transportation capacity is conditionally offered in a manner as described above.

If the market behaviour is such that the transportation capacity of the producer 2′ is needed, the proceeds for the producer 2′ will equal the difference in the market price for the energy between the area 4 and the area 5. On average, said proceeds will be higher because no guarantee premium needs to be paid, since the market behaviour is known. This situation is shown in FIG. 4D. If the market behaviour is such that the difference in the energy prices in the various areas 4, 5 would suggest a direction of transportation contrary to the intended transportation of energy over the network connection 6, the transportation capacity will not be used.

In a third situation, the energy producer 2′ will make the decision whether or not to use the already acquired transportation capacity conditional on the energy prices in the areas 4 and 5. This situation can be effected by means of a combination of a conditional inter-area bid and a bid to sell and a bid to buy at the various servers 9 and 10 for the areas 4 and 5, respectively. If the bid to buy and the bid to sell as well as the conditional bid are accepted, energy will be supplied as described above for the first situation and shown in FIG. 4C. If only the conditional inter-area bid is accepted, whereas the bid to sell and the bid to buy are not accepted, only the rights to transportation capacity that had already been acquired by the producer 2′ will be sold.

The second manner of making the transportation rights of the market parties available is to offer said transportation rights for an implicit auction between the areas 4 and 5, with the transportation being arranged by a third party. This way of making transportation rights available corresponds to the auctioning of transportation rights of the network operators as in the first option, with this difference that the proceeds now go to the holder of said transportation rights. The same three situations as described above may occur in that case, with this difference that the original holder of the transportation rights does not have to arrange the transportation between the areas itself, and consequently does not need to buy energy in one area 4, 5 and sell it in the other area 5, 4. This is done for said holder by the third party, which functions as a so-called “shipper”.

In the foregoing, the situation for two areas 4, 5, within which the energy network 1 is present, has been discussed. As already said before, energy networks will generally be much more complex. Hereinafter it will be briefly indicated how the method and the system according to the invention can be used for an energy network 1 in three areas 4, 5 and 12.

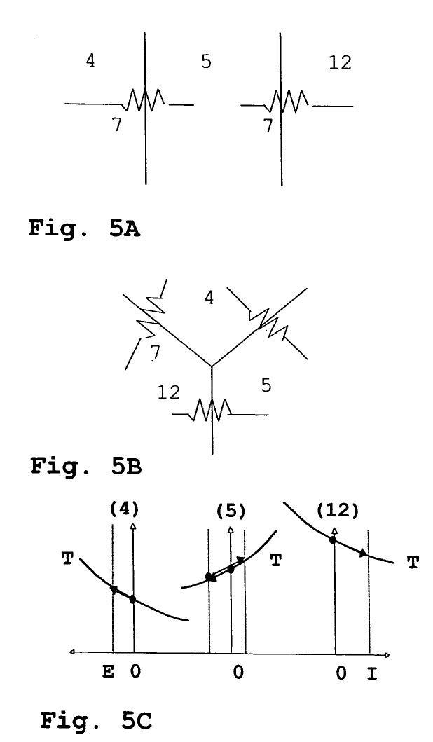

FIGS. 5A and 5B show examples in which the areas 4, 5 and 12 lie adjacently to each other, with the area 5 forming a transition area and the three areas 4, 5 and 12 meeting at a particular place.

FIG. 5C shows the transportation curves T for the example with the transition area 5. The transition area 5 has network connections 6 having a limited transportation capacity 7 to the two areas 4 and 12. In the intermediate area, energy is imported as well as exported and the transportation capacity of the network connections may be sufficient or insufficient in both cases, or insufficient in one case as regards the desired energy transport.

For the areas shown in FIG. 5B, the optimisation process must be used for the three network connections 6 between the areas 4, 5 and 12. This process may result in a common energy price CEP for the areas 4, 5 and 12, or in two or three different adjusted energy prices AEP4, AEP5 and/or AEP12.

The system and the method according to the invention will become more and more attractive to the energy producers 2, 2′ if more areas are added. The energy producers only need to make a bid to sell in the area in which the production takes place and a bid to buy in the destination area. In the transition areas, only conditional bids with regard to the previously acquired transportation rights need to be made.

The servers 9-11 may be arranged in such a manner that it becomes possible for market parties to place “block-bids”. Supply and demand do not take place per unit of time in this case, but for several successive units of time without any “holes” being present therebetween. This may be necessary in view of the slowness of thermal units, which is technically determined. The blocks are either standardised between the servers 9-11 in that case, or an iterative optimisation process takes place. The first possibility is simpler from a technical viewpoint, but it limits the optimisation possibilities for the market players; the second possibility is technically more complicated, but it allows a better optimisation possibility.

The advantages of the method and the system according to the invention as described above are legion. The financial risks for the holders of rights to transportation capacity are lowered, and an optimum situation for the participants in the market can be achieved by creating bids to sell and bids to buy on the various markets in combination with the making of conditional inter-area bids. There is no need to trade the entire transportation capacity on a daily basis; transportation capacity may be traded on a yearly basis or on a monthly basis and subsequently be included in the optimisation process according to the invention. The invention also ensures that the limited capacity of the network connection is used optimally, also if it has already been allocated to a market party. Unnecessary disruption of the market is moreover prevented by limiting the volume of energy that is transported at market prices. The exchanges can retain their own individuality (e.g. by using different trading systems), and it is possible to achieve compatibility with the present system of trading energy and transportation capacity.

As will be apparent to those skilled in this field of the art, modifications and adaptations of the embodiments as described above are possible when using the invention without departing from the spirit thereof. Accordingly, the spirit of the invention should be interpreted in accordance with the following claims.

1. A method for regulating the energy flow in an energy network comprising at least a first area and a second area comprising producers and consumers, in which the energy network comprises at least one network connection that limits the transportation capacity of the energy network between said first area and said second area, which method comprises the steps of:
fixing isolated energy prices (IEP4, IEP5) in the first area and in the second area in proportion to the intended energy production by the producers and the intended energy consumption by the consumers;
adjusting said isolated energy prices (IEP4, IEP5) in said first area and in said second area on the basis of simulated transportation of energy over the network connection and on the basis of the available transportation capacity; and
making data on the energy flow for the first area and the second area accessible to the producers and/or the consumers and/or an operator of the network connection.

2. The method according to claim 1, wherein the energy flow data comprise a common adjusted energy price (CEP) for the first area and the second area or the adjusted energy prices (AEP4, AEP5) for the first area and the second area.

3. The method according to claim 1, wherein the energy flow data comprise data on the actual transportation of energy over the network connection.

4. The method according to claim 1 and further comprising deciding on the basis of the energy flow data whether bids with regard to the intended energy production and/or the intended energy demand will be accepted.

5. The method according to claim 1 and further comprising making available transportation capacity at least partially, wherein rights to transportation capacity are made available by the producers and/or the consumers.

6. The method according to claim 5, wherein the rights to transportation capacity are conditionally made available.

7. The method according to claim 6, wherein said condition relates to the difference between the isolated energy prices (IEP4, IEP5) in the areas.

8. The method according to claim 5, wherein the rights to transportation capacity are made available by making an inter-area bid, whether or not in combination with a bid to sell in one area and a bid to buy in the other area.

9. The method according to claim 5, wherein the rights to transportation capacity are made available for implicit auctioning by a third party.

10. A computer readable medium having instructions for regulating the energy flow in an energy network, wherein the instructions comprise at least code portions for carrying out the method according to claim 1.

11. A system for the electronic auctioning over an auctioning network of energy adapted for an energy network comprising at least a first area and a second area comprising producers and consumers, in which the energy network comprises at least one network connection that limits the transportation capacity of the energy network between said first area and said second area, wherein the system comprises a first unit and a second unit adapted for receiving bids relating to the supply of and the demand for energy in said first area and said second area for the purpose of obtaining an isolated auctioning price (IEP4, IEP5) in said first area and said second area in dependence on the supply of and the demand for energy, and wherein the system furthermore comprises a combination server adapted for adjusting the isolated energy prices (IEP4, IEP5) in the first area and in the second area on the basis of simulated transportation of energy over the network connection and the available transportation capacity, and wherein the system is also adapted for making the adjusted energy prices accessible at least to the producers and/or the consumers via the auctioning network.

12. The system according to claim 11, wherein the auctioning data comprise a common adjusted energy price (CEP) for the first area and the second area, or the adjusted energy prices (AEP4, AEP5) for the first area and the second area.

13. The system according to claim 11, wherein the auctioning data comprise data on the actual transportation of energy over the network connection.

14. The system according to claim 11, wherein the system is adapted for deciding, on the basis of the energy flow data, whether bids relating to the intended energy production and/or the intended energy demand will be accepted.

15. The system according to claim 11, wherein said first unit and said second unit are adapted for making available rights to transportation capacity by the producers and/or the consumers.

16. The system according to claim 11, wherein the system is adapted for making an inter-area bid, whether or not in combination with a bid to sell in one area and a bid to buy in the other area.

17. A computer readable medium having instructions operable on a computer for the auctioning of energy in an energy network over an auctioning network, wherein the instructions comprise at least code portions for carrying out the tasks of said first unit and/or the second unit and/or the arithmetic unit according to claim 10.

18. A method for regulating the energy flow in an energy network comprising at least a first area and a second area comprising producers and consumers, in which the energy network comprises a network connection that limits the transportation capacity of the energy network, in a system comprising a combination server, which is communicatively linked to servers of the areas for one or more user units of the producers and the consumers, which method comprises the following steps, wherein:
the servers receive one or more data strings from the units of the producers and the consumers, which data strings contain data on the intended energy production and the intended energy consumption, respectively;
the combination server fixes or receives isolated energy prices (IEP4, IEP5) in the first area and the second area in proportion to the intended energy production by the producers and the intended energy consumption by the consumers;
the combination server adjusts the isolated energy prices (IEP4, IEP5) in the first area and in the second area on the basis of simulated transportation of energy over the network connection and the available transportation capacity; and
the combination server makes energy flow data for the first area and the second area accessible to the producers and/or the consumers and/or to an operator of the network connection, or said data are made accessible via said combination server.

19. The method according to claim 18, wherein the energy flow data comprise a common adjusted energy price (CEP) for the first area and the second area or the adjusted energy prices (AEP4,AEP5) for the first area and the second area.

20. The method according to claim 18, wherein the energy flow data comprise data on the actual transportation of energy over the network connection.

21. The method according to claim 18 and further comprising deciding on the basis of the energy flow data whether bids with regard to the intended energy production and/or intended energy consumption will be accepted.

22. The method according to claim 18 and further comprising making available transportation capacity at least partially, wherein rights to transportation capacity are made available by the producers and/or the consumers.

23. The method according to claim 22, wherein the rights to transportation capacity are conditionally made available.

24. The method according to claim 23, wherein the condition relates to the difference between the isolated energy prices (IEP4,IEP5) in the first and second area.

25. The method according to claim 22 and further comprising making available the rights to transportation by making an inter-area bid, whether or not in combination with a bid to sell in one area and to buy in another area.

26. The method according to claim 22, wherein the rights to transportation capacity are made available for implicit auctioning by a third party.

27. A computer readable medium having instructions operable on a computer for regulating the energy flow in an energy network, wherein the instructions comprise at least code portions for carrying out the method according to claim 18.
